(19) United States
(12) Patent Application Publication
(10) Pub. No.: US 2011/0281024 A1
(43) Pub. Date: Nov. 17, 2011

(54) METHOD FOR PREVENTING OR REDUCING SILVER MIGRATION IN THE CROSSOVER AREAS OF A MEMBRANE TOUCH SWITCH

(75) Inventors: John C. Crumpton, Bahama, NC (US); Robert Paul Waldrop, Chapel Hill, NC (US)

(73) Assignee: E. I. DU PONT DE NEMOURS AND COMPANY, Wilmington, DE (US)

(21) Appl. No.: 12/944,205

(22) Filed: Nov. 11, 2010

Related U.S. Application Data
(60) Provisional application No. 61/260,139, filed on Nov. 11, 2009.

(51) Int. Cl. B05D 5/12; B05D 3/00; B05D 1/38

(52) U.S. Cl. 427/97.6

(57) ABSTRACT

Disclosed is the use of carbon layers as barriers to prevent silver migration in circuitry crossovers, either over a bottom circuitry layer and/or beneath subsequent circuit layers.

### FIELD OF THE INVENTION

The present invention is directed to a method for preventing or reducing silver migration at circuit crossover areas of a membrane touch switch by the use of a carbon layer(s) to encapsulate the silver and reduce or prevent silver migration.

### TECHNICAL BACKGROUND OF THE INVENTION

Silver conductors of opposite polarity in the crossover areas of membrane touch switches are typically separated by dielectric insulating layers. With exposure to time, elevated temperatures and humidity, silver migration may occur at circuit crossover areas. Previously, only dielectric insulating layers have been used as insulation between circuitry layers of opposite polarity and have been the only means used to prevent silver migration between these circuitry layers. These methods have not served to adequately resolve the silver migration problem in many applications.

### SUMMARY OF THE INVENTION

The invention relates to a method of forming a membrane touch switch including: (a) coating a substrate with a silver composition; (b) drying or curing the silver composition; (c) applying a dielectric composition over the silver; (d) drying or curing the dielectric composition; (e) applying a top layer of silver composition over the dielectric; and (f) drying or curing the silver composition composition to form a circuit. The invention further relates to a switch produced by such method.

In a further aspect, the invention relates to a method of making a membrane touch switch in which one or two areas of carbon are coated over and or under the silver circuitry layers. This method of forming a membrane touch switch includes: (a) coating a substrate with a bottom silver composition; (b) drying or curing the silver composition; (c) applying a carbon coating on top of said silver composition; (d) drying or curing the carbon composition; (e) applying a dielectric composition over said carbon; (f) drying or curing the dielectric composition; (g) applying a carbon coating on said dielectric; (h) applying a top layer of silver over said carbon; and (i) drying or curing the silver composition to form a circuit. A further aspect relates to a switch produced by such method.

A further aspect relates to: a method of forming a membrane touch switch including: (a) coating a substrate with a bottom silver composition; (b) drying or curing the silver composition; (c) applying a carbon coating on top of said silver composition; (d) drying or curing said carbon composition; (e) applying a dielectric composition over said carbon; (f) drying or curing the dielectric composition; (g) putting a top layer of silver on said dielectric; and (h) drying the silver paste composition to form a circuit.

A further aspect relates to a method of forming a membrane touch switch including: (a) coating a substrate with a bottom silver composition; (b) drying or curing the silver composition; (c) applying a dielectric composition over said silver; (d) drying or curing the dielectric composition; (e) applying a carbon coating on top of said dielectric composition; (f) drying or curing the carbon composition; (g) putting a top layer of silver on said carbon; and (h) drying the silver paste composition to form a circuit. A further aspect relates to a switch produced by such method.

### BRIEF DESCRIPTION OF DRAWING

FIG. 1 shows a cross sectional view of the current practice without carbon coating. This is a comparative figure.

FIG. 2 shows a top view of the embodiment pictured in FIG. 1

FIG. 3 shows a cross sectional view of an embodiment of the invention with a carbon print beneath the top silver and next to the dielectric and with silver on the top of the carbon.

FIG. 4. shows a top view of FIG. 3.

FIG. 5 shows an embodiment of the invention with two carbon prints.

FIG. 6 shows a top view of FIG. 5.

FIG. 7 shows an embodiment of the inventions with carbon on top of the bottom silver and next to the dielectric.

FIG. 8 shows a top view of FIG. 7.

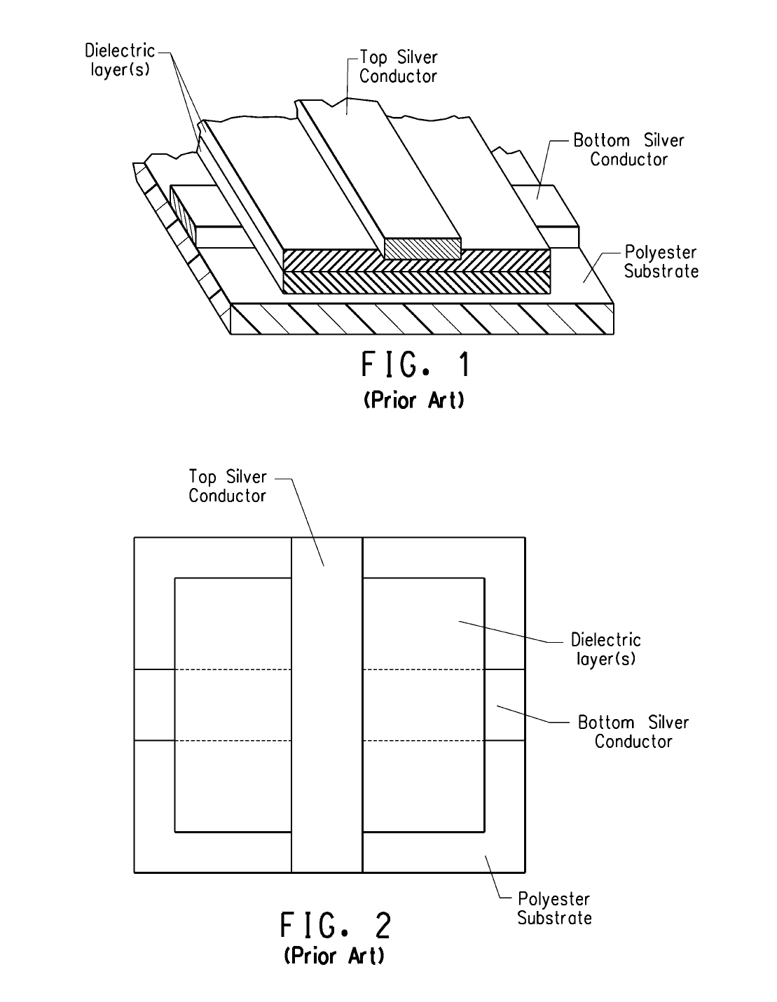

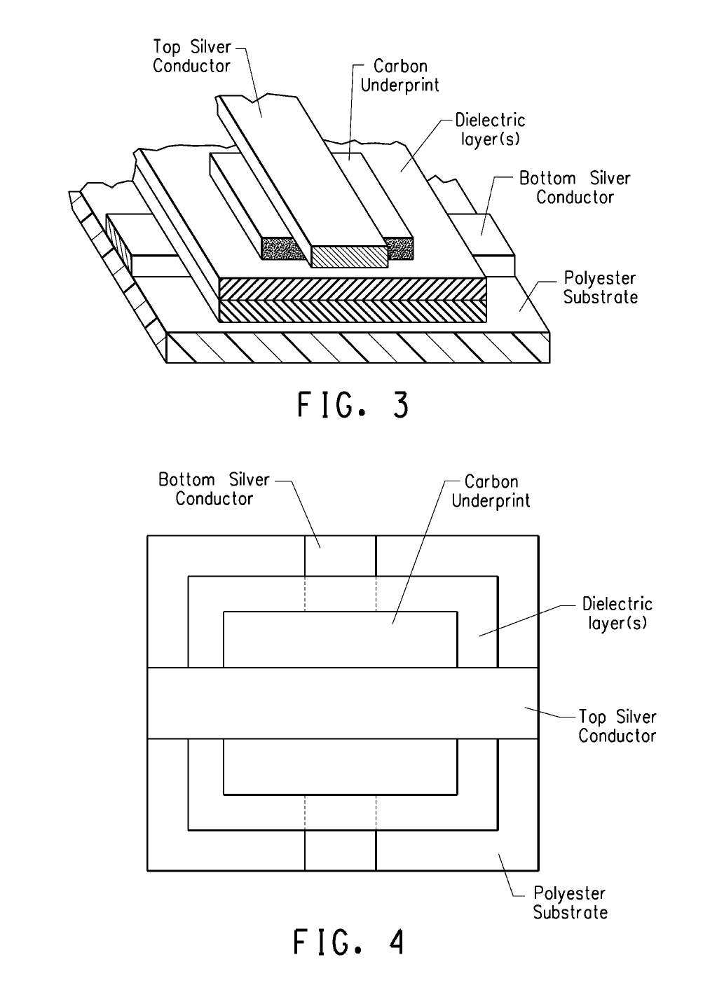

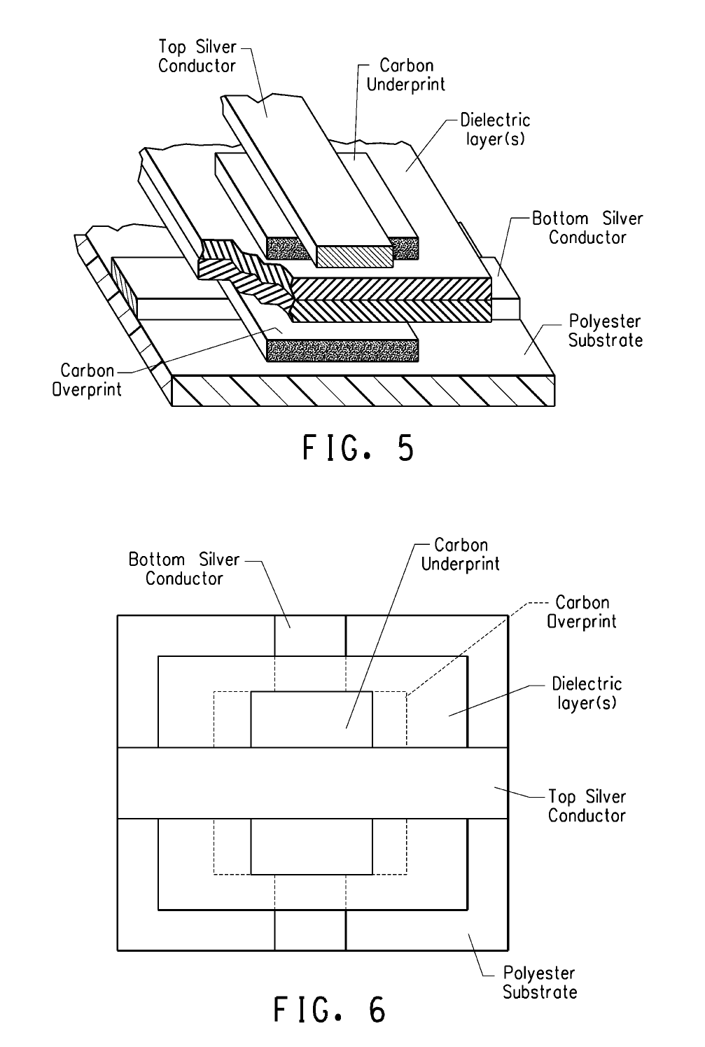

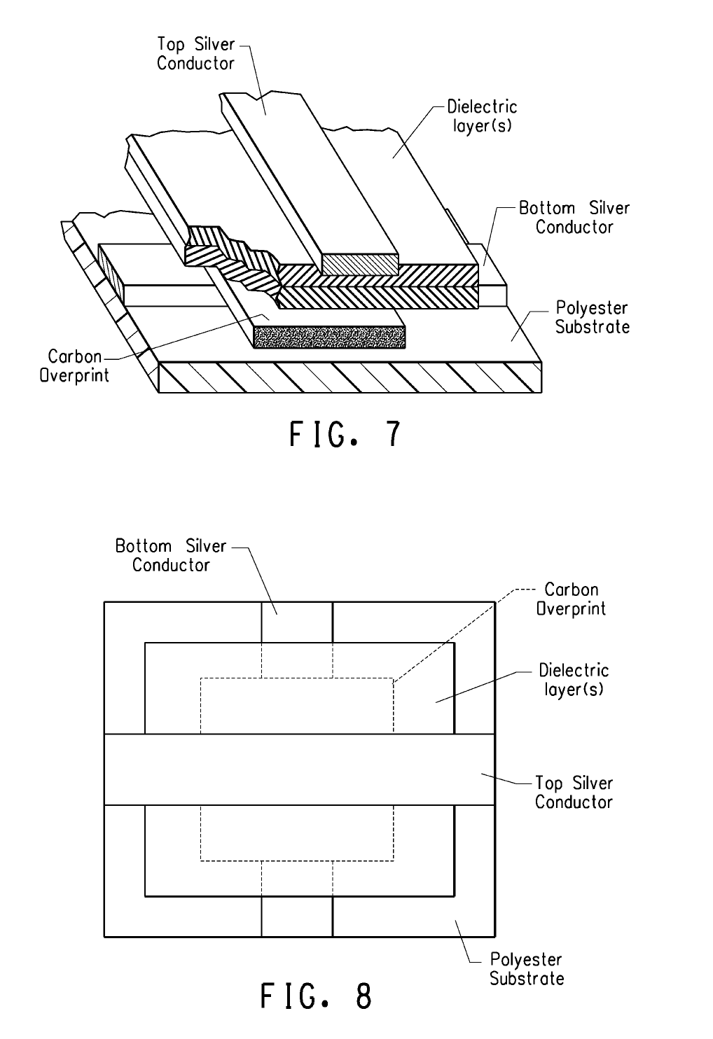

### DETAILED DESCRIPTION

There are hundreds of membrane touch switch manufacturers globally and thousands of applications in which silver is used and where silver migration, as described, may cause membrane switches to fail in the application. The present invention relates to the use of silver circuitry prints or patterns, a carbon overprint or layer on top of or beneath the silver circuitry prints or layers and a dielectric insulating layer(s) between the silver circuitry prints to construct a membrane touch switch crossover, which eliminates or decreases silver migration at the circuit crossover layers.

Carbon has long been used in membrane touch switches as an overlayer or overprint on silver circuitry to prevent silver migration between adjacent circuit lines of opposite polarity on the same surface. However, it has not been used to prevent silver migration between dielectric insulating layers separating overlapping or crossover circuitry layers of opposite polarity.

A thick film conductor composition may be used on a substrate to form a membrane touch switch. The membrane switch is formed by applying the silver conductor composition onto a substrate, drying or curing the composition, applying subsequent dielectric and silver conductor circuitry layers in the same manner to make a circuit and applying voltage across the circuit. The present invention relates to the use of an inert carbon layer as a barrier over the top of or beneath a silver conductive layer installed on a substrate.

A thick conductor composition useful herein is described in U.S. Pat. No. 6,939,484, incorporated herein by reference. Also disclosed therein is a method of forming a membrane touch switch comprising (a) preparing a conductor paste composition; (b) applying the conductor paste composition onto a substrate; (c) drying the composition to form a circuit and then (d) applying a voltage across the circuit formed in (c). In this conventional method, there area no carbon coatings to protect the silver from migration.

In a circuit like the one above, there are circuit crossover areas, and silver migration can occur at these crossover areas. The methods and device described herein prevent or reduce migration by depositing an encapsulating layer, by printing or other processes, of inert carbon on top of the first silver circuit layer and or on top of the insulating layer and beneath the top silver conductor layer. This carbon may also be used beneath any other subsequent circuit layers.

There is a need to prevent silver migration through dielectric insulating layers used in membrane touch switches. The present process addresses the issue of silver migration through dielectric insulating layers by depositing an encapsulating layer, by printing or by some other method, of inert carbon on top of a first silver circuit layer, and on top of the insulating layers and between other subsequent silver circuit layers.

A simple membrane touch switch is formed as follows: (a) prepare a conductor paste composition; (b) apply the conductor paste composition onto a substrate; (c) dry or cure the composition to form a circuit; (d) prepare a dielectric paste composition; (e) apply the dielectric insulating layers over the top of the initial circuitry layer, dry or cure the dielectric composition layer or layers; (f) apply a second conductor layer as in b and c above, on top of the dielectric insulating layers; (g) apply a voltage across the circuit formed in (c through f).

In the above embodiment in the absence of a carbon, there is nothing to protect the silver used in the conductor pastes from migrating through the dielectric layer(s).

In the present invention, carbon prevents the silver from migrating. One embodiment of a membrane touch switch is as follows.

The invention relates to methods of forming a membrane touch switch. In an embodiment, the method of forming a membrane touch switch includes:
(a) coating a substrate with a silver composition;
(b) drying or curing the silver composition
(c) applying a dielectric composition over the silver
(d) drying or curing the dielectric composition
(e) applying a top layer of silver composition over the dielectric
(f) drying or curing the silver composition composition to form a circuit.

Contemplated is a switch produced by such method.

A second embodiment, with one or two areas of carbon coating over and or under the silver circuitry layers, is shown as follows:

A method of forming a membrane touch switch comprising:
(a) coating a substrate with a bottom silver composition;
(b) drying or curing the silver composition
(c) applying a carbon coating on top of said silver composition.
(d) drying or curing the carbon composition
(e) applying a dielectric composition over said carbon
(f) drying or curing the dielectric composition
(g) applying a carbon coating on said dielectric
(h) applying a top layer of silver over said carbon
(i) drying or curing the silver composition to form a circuit.

Contemplated is a switch produced by such method.

A third embodiment is described as follows:
A method of forming a membrane touch switch comprising:
   (a) coating a substrate with a bottom silver composition;
   (b) drying or curing the silver composition
   (c) applying a carbon coating on top of said silver composition
   (d) drying or curing said carbon composition
   (e) applying a dielectric composition over said carbon
   (f) drying or curing the dielectric composition
   (g) putting a top layer of silver on said dielectric
   (h) drying the silver paste composition to form a circuit.

A fourth embodiment is described as follows:
A method of forming a membrane touch switch comprising:
   (a) coating a substrate with a bottom silver composition;
   (b) drying or curing the silver composition
   (c) applying a dielectric composition over said silver
   (d) drying or curing the dielectric composition
   (e) applying a carbon coating on top of said dielectric composition
   (f) drying or curing the carbon composition
   (g) putting a top layer of silver on said carbon
   (h) drying the silver paste composition to form a circuit.
      Contemplated is also is a switch produced by such method.

In the above embodiments, substrates that may be used include, but are not limited to: DuPont ST505, ST504 polyester films, DuPont Kapton Polyimide films, polycarbonate films, FR-4 circuit boards. Other substrates useful in the invention will be understood by one of skill in the art.

In the above embodiments, silver conductor compositions that may be used include, the following DuPont products: Dupont 5000, 5021, 5025, 5028, 5029, 5064, 5069, 5524, 9169, PV428, PV410, and PV412. Other conductive compositions useful in the invention will be understood by one of skill in the art.

In the above embodiments, carbon-based conductor compositions that may be used in include, but are not limited to the following DuPont products: DuPont 5069, 7102, 7105, 8144, and PV480. Other conductive compositions useful in the invention will be understood by one of skill in the art.

In the above embodiments, dielectric compositions that may be used include, but are not limited to: DuPont 5018, 5018A, 5018G, 3571, and 5036. Other dielectric compositions useful in the invention will be understood by one of skill in the art.

In the above embodiments, screens that may be used include, but are not limited to: Stainless steel mesh with wire diameters ranging from 0.7 mil to 1.3 mil and mesh counts ranging from 200-400 wires per inch, and Polyester thread mesh with thread diameters ranging from 1 mil to 2 mil and mesh counts ranging from 200-400 threads per inch. Other screens useful in the invention will be understood by one of skill in the art.

### EXAMPLES

### Example 1

Step 1—A solvent-based or UV-cured silver-containing conductor composition or paste such as DuPont 5025 will be applied to polyester, polyimide, polycarbonate or other flexible or rigid substrate, such as DuPont-Tejin Films ST505 5 mil polyester film to form bottom circuit lines or traces. These circuit lines are typically 5-500 mils in width. This silver-containing composition will then be dried in a belt or box oven at temperatures of between 100 C-250 C for 0.5-45 minutes or cured in a UV curing device at the required wavelength for the required time thereby forming the bottom circuitry layer.

Step 2—A solvent-based or UV-cured carbon-based conductor composition or paste such as DuPont 7102, will be applied to the above mentioned silver circuit at crossover areas by screen printing using stainless steel or polyester screens of varying mesh counts and wire or thread diameters or other pattern-forming methods such as ink jet or flexographic printing to form an overprint on the bottom circuitry lines or traces in a manner such that it overlaps the silver, thereby covering the silver in the desired areas where the crossover circuits will occur. This carbon-based layer provides an inert coating on the silver layer which reduces or prevents silver migration. This carbon-based composition will then be dried in a belt or box oven at temperatures of between 100 C-250 C for 0.5-45 minutes or cured in a UV curing device at the required wavelength for the required time.

Step 3—A solvent-based or UV-cured dielectric insulator composition or paste as described above such as DuPont 5018, will be applied to the above mentioned carbon and silver on the polyester, polyimide, polycarbonate or other flexible or rigid substrate by screen printing using stainless steel or polyester screens of varying mesh counts and wire or thread diameters or other pattern-forming methods such as ink jet or flexographic printing to form the dielectric layer(s). This dielectric is used as an insulating layer between the crossover circuits which are of opposite polarity. This dielectric composition will then be dried in a belt or box oven at temperatures of between 100 C-250 C for 0.5-45 minutes or cured in a UV curing device at the required wavelength for the required time. This dielectric deposition process may be repeated in several iterations to increase the thickness of the overall dielectric layer.

Step 4—A solvent-based or UV-cured carbon-based conductor composition or paste, as described in step 2 above, will be applied to the above-mentioned dielectric by screen printing or other pattern-forming methods in a manner such that it overlaps the area where the silver will be applied in the next layer. This carbon-based layer provides an inert coating beneath the following silver layer which will be applied on top of said carbon. This carbon-based composition will then be dried in a belt or box oven at temperatures of between 100 C-250 C for 0.5-45 minutes or cured in a UV curing device at the required wavelength for the required time.

Step 5—A solvent-based or UV-cured silver-containing conductor composition or paste as described above in step 1 will be applied to the above-mentioned carbon on the polyester, polyimide, polycarbonate or other flexible or rigid substrate by screen printing or other pattern-forming methods, comprising the top circuitry layer. This silver-containing composition will then be dried in a belt or box oven at temperatures of between 100 C-250 C for 0.5-45 minutes or cured in a UV curing device at the required wavelength for the required time.

### Example 2

As in steps 1-5 above (Example 1), but excluding step 2 entirely.

### Example 3

As in steps 1-5 above (Example 1), but excluding step 4 entirely.

What is claimed is:

1. A method of forming a membrane touch switch comprising:
(a) coating a bottom substrate with a silver composition and drying or curing same
(b) applying a carbon coating on top of said silver composition and drying or curing same
(c) coating the carbon with a dielectric composition and drying or curing same
(d) applying a silver paste composition onto the dielectric and drying or curing same to form a circuit.

2. A method of forming a membrane touch switch comprising:
(a) coating a bottom substrate with a silver composition and drying or curing same
(b) applying a dielectric composition onto said silver composition and drying or curing same
(c) applying a carbon composition onto said dielectric composition and drying or curing same
(d) applying a silver paste composition to said carbon to form a circuit.

3. A method of forming a membrane touch switch comprising:
(a) coating a bottom substrate with a silver composition and drying or curing same
(b) applying a carbon coating on top of said silver composition and drying or curing same
(c) coating the carbon with a dielectric composition and drying or curing same
(d) applying a carbon paste composition onto the dielectric and drying or curing same.
(e) applying a silver paste composition onto the carbon and drying or curing same to form a circuit.

4. The method of claims 1 through 3 wherein the silver is DuPont 5025, the dielectric is Dupont 5018 and the carbon is DuPont 8144.
